(19) United States
(12) Patent Application Publication
(10) Pub. No.: US 2026/0311552 A1
(43) Pub. Date: Oct. 8, 2026

(54) GAME SYSTEM WITH PLURAL RANDOM NUMBER GENERATION AND RANDOM ODDS FEATURES

(71) Applicant: JUMBO TECHNOLOGY CO., LTD., TAICHUNG (TW)

(72) Inventors: Shun Tsung HSU, TAICHUNG (TW); Chang Yi WANG, TAICHUNG (TW)

(21) Appl. No.: 19/711,835

(22) Filed: Jun. 17, 2026

Related U.S. Application Data
(63) Continuation-in-part of application No. 19/193,645, filed on Apr. 29, 2025.
Application No. 19/193,645 is a continuation of application No. 19/072,196, filed on Mar. 6, 2025, now abandoned.
Application No. 19/072,196 is a continuation-in-part of application No. 17/915,980, filed on Apr. 1, 2020, now Pat. No. 12,249,214.
Application No. 19/072,196 is a continuation-in-part of application No. 18/251,793, filed on Dec. 3, 2020.

(51) Int. Cl. G07F 17/32; G06T 7/70

(52) U.S. Cl. CPC G07F 17/323; G06T 7/70; G07F 17/3209; G07F 17/3211

(57) ABSTRACT

A game system with plural random number generation and random odds features includes a game processing unit, a user interface unit, a plurality of random number generating units, an odds processing unit, a betting unit, and a payout unit. The plurality of random number generating units respectively randomly generate one of a plurality of game results on a time axis according to a cycle schedule. The odds processing unit generates a plurality of variable odds and enables the plurality of variable odds to replace at least one of a plurality of payout odds in a many-to-one manner, thereby generating a random odds set. The betting unit ends betting upon receiving a betting signal to generate betting data. The payout unit pays out according to the latest generated game result, the betting data, and the random odds set.

### CROSS-REFERENCE TO RELATED APPLICATIONS

This application is a continuation-in-part of U.S. patent application Ser. No. 19/193,645, filed Apr. 29, 2025, which is:
a continuation of U.S. patent application Ser. No. 19/072,196, filed Mar. 6, 2025, which is:
   a continuation-in-part of U.S. patent application Ser. No. 17/915,980, filed Sep. 29, 2022, which is a national stage entry of International Application Ser. No. PCT/CN2020/082704, filed Apr. 1, 2020; and
   a continuation-in-part of U.S. patent application Ser. No. 18/251,793, filed May 4, 2023, which is a national stage entry of International Application Ser. No. PCT/CN2020/133669, filed Dec. 3, 2020.

Each of these priority applications is incorporated by reference herein in its entirety.

### FIELD OF THE INVENTION

The present application relates to game systems. More particularly, the application relates to game systems with plural random number generation and random odds features.

### BACKGROUND OF THE INVENTION

U.S. Pat. No. 9,646,459 discloses an incentive apparatus for a gambling game system, which generates dynamic bonus odds as payout odds of the gambling game system, so that players may expect to additionally obtain rewards from the gambling game system, thereby increasing the attractiveness of the gambling game system and accordingly increasing utilization of the gambling game system. This manner of generating dynamic raised odds increases a Return to Player (RTP) rate. Since the RTP rate usually has to comply with regulatory requirements or satisfy operating profit considerations, the number and numerical values of the dynamic raised odds are strictly limited. As a result, the numerical values cannot be substantially increased, and it is therefore difficult to produce an effect of attracting players.

U.S. Pat. No. 10,176,669 B2 discloses an electronic gaming system adapted for simultaneous use of multiple users. The electronic gaming system includes a game server which allows the plurality of players to connect and log in to play a game. The game includes a plurality of game results. The plurality of players place bets on the plurality of game results. After betting ends, the game server generates one of the plurality of game results through a random number generating unit. When the generated game result matches the bets placed by the plurality of players, the plurality of players may obtain corresponding payouts.

Since the electronic gaming system can be played by a plurality of players simultaneously, a fixed betting time is set with reference to the thinking time of most players, so that the plurality of players can place bets within the betting time. However, it is difficult for the fixed betting time to satisfy the needs of every player. As a result, players often do not have enough time to place bets or need to wait for the betting time to end after placing bets.

### SUMMARY OF THE INVENTION

Accordingly, a main object of the present application is to provide a game system that allows players to place bets at any time and shortens waiting time, while also having random odds features.

To achieve the object described above, the present application provides a game system with plural random number generation and random odds features for providing a game. The game has a Return to Player (RTP) rate. The game has a plurality of game results and a plurality of payout odds. The plurality of payout odds correspond respectively to the plurality of game results. The plurality of game results have probabilities of occurrence, respectively, and the RTP rate is calculated according to the probabilities of occurrence of the plurality of game results and the plurality of payout odds. The game system includes a game processing unit, a user interface unit, a plurality of random number generating units, an odds processing unit, a betting unit, and a payout unit. The game processing unit controls operation of the game and allows a player to play a game round. The user interface unit is connected to the game processing unit and displays a game screen of the game round and a plurality of betting areas. The plurality of betting areas correspond respectively to the plurality of game results.

The plurality of random number generating units are connected to the game processing unit and operate repeatedly and independently on a time axis according to cycle schedules. In each cycle schedule, each random number generating unit randomly generates one of the plurality of game results according to the probability of occurrence. Each cycle schedule includes a cycle starting point, an action starting time point, a stop-accepting-bets time point, a result display time point, and a cycle end point. The stop-accepting-bets time point is located between the action starting time point and the result display time point. In each cycle schedule, each random number generating unit has an allowed betting period, and the allowed betting period is located between the cycle starting point and the stop-accepting-bets time point.

The odds processing unit is connected to the game processing unit and generates a plurality of variable odds in each cycle schedule of each random number generating unit. The plurality of variable odds respectively have probabilities to be selected. In each cycle schedule, the odds processing unit selects one of the variable odds according to the probability to be selected of each of the plurality of variable odds, and the plurality of variable odds replace at least one of the plurality of payout odds in a many-to-one manner, so that the RTP rate has a variation value and a random odds set is generated in each cycle schedule. Each random odds set is used in the corresponding cycle schedule of the corresponding random number generating unit. Values of a portion of the plurality of variable odds are lower than values of corresponding ones of the payout odds. In other embodiments, the game may be provided with a plurality of basic odds corresponding respectively to the plurality of game results, and the odds values of the plurality of variable odds are greater than or equal to the odds values of the corresponding basic odds.

The betting unit is connected to the game processing unit and receives a bet on the plurality of betting areas in the game round. When at least one of the plurality of random number generating units is in the allowed betting period, the betting unit ends betting upon receiving a betting signal, thereby generating betting data and forming a finished-betting time point on the time axis. At the same time, the game processing unit filters the plurality of random number generating units to identify those satisfying a filtering condition. The filtering condition is that the plurality of random number generating units are in the allowed betting period at the finished-betting time point. The game processing unit further obtains the random odds set used in the latest cycle schedule among the random number generating units satisfying the filtering condition, and controls the plurality of betting areas to display the random odds set after the stop-accepting-bets time point on the time axis.

The payout unit is connected to the game processing unit. After the finished-betting time point, the game processing unit obtains the latest generated game result in the cycle schedule among the plurality of random number generating units satisfying the filtering condition, and the game processing unit controls the payout unit to pay out according to the latest generated game result, the betting data, and the random odds set.

### BRIEF DESCRIPTION OF THE DRAWINGS

FIG. 1 is an exemplary system architecture diagram of the present application.

FIG. 2 is an exemplary schematic diagram of a gaming machine to which the present application is applied.

FIG. 3 is an exemplary game screen diagram of the present application.

FIG. 4 is an exemplary cycle schedule diagram of the plurality of random number generating units of the present application.

FIG. 5 is an exemplary diagram of another finished-betting time point of the present application.

FIG. 6 is an exemplary diagram of the present application showing a random odds set displayed on the game screen.

FIG. 7 is an exemplary game screen diagram of the present application showing a parlay bet.

FIG. 8 is an exemplary game screen diagram of the present application showing a synthesized image integrating virtual and real elements.

### DETAILED DESCRIPTION

The detailed description and technical contents of the present application are described below with reference to the drawings.

The present application provides a game system with plural random number generation and random odds features for providing a game. The game has a Return to Player (RTP) rate. The game has a plurality of game results and a plurality of payout odds corresponding respectively to the plurality of game results. The plurality of game results have probabilities of occurrence, respectively, and the RTP rate is calculated according to the probabilities of occurrence of the plurality of game results and the plurality of payout odds. For example, when the random number generating unit is Triple Zero Roulette, if the game results available for betting in Triple Zero Roulette are simplified into only 39 kinds, namely 0, 00, 000, and 1 to 36, i.e., straight bets, the odds value of a single number may be represented as “35×”, which means that the original bet is excluded and the player wins 35 times the bet. The payout actually obtained by the player is 36 (35+1) times the bet, including the returned original bet. In other words, the payout odds are 36 times. Therefore, the RTP rate is the product of the probability of occurrence (1/39) and the payout odds (36), i.e., 1/39*(36)≈92.31%.

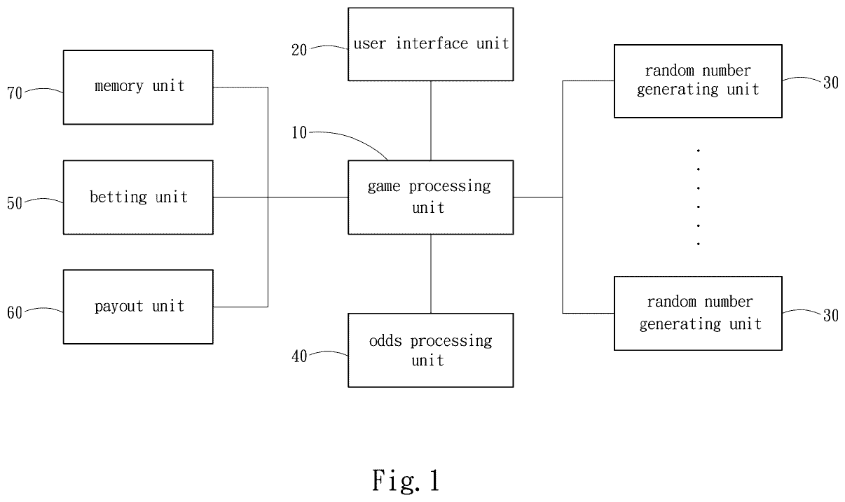

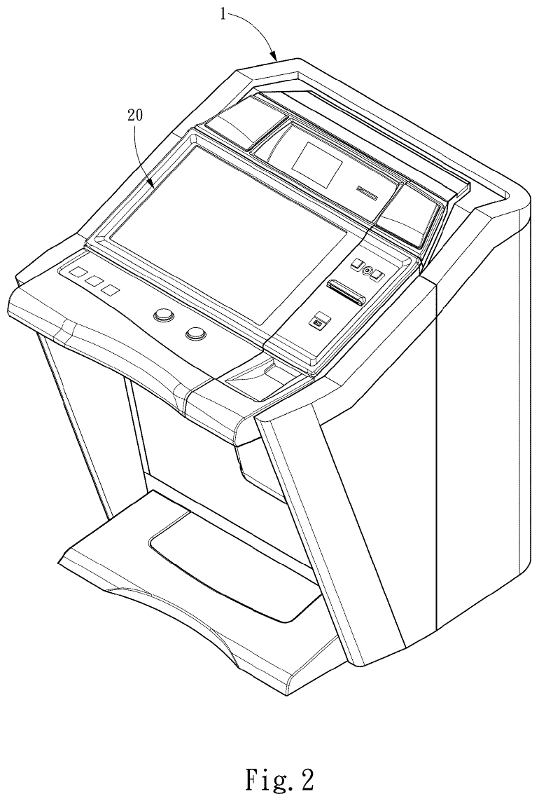

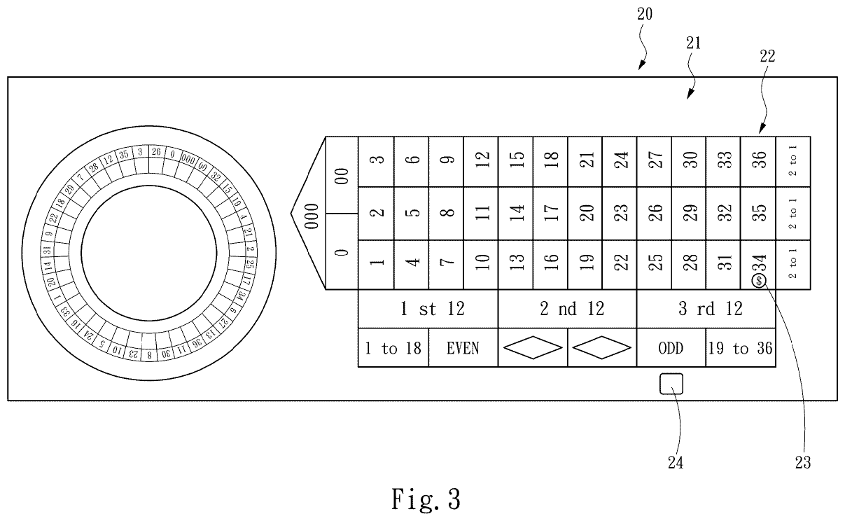

The detailed embodiments of the present application are described as follows. Referring to FIG. 1, FIG. 2, and FIG. 3, the game system includes a game processing unit 10, a user interface unit 20, a plurality of random number generating units 30, an odds processing unit 40, a betting unit 50, and a payout unit 60. The game processing unit 10 controls operation of the game and allows a player to play one game round. The user interface unit 20 is connected to the game processing unit 10 and displays a game screen 21 of the game round and a plurality of betting areas 22, and the plurality of betting areas 22 respectively correspond to the plurality of game results. In one embodiment, the user interface unit 20 is a touch screen and is configured on a gaming machine 1. In other embodiments, the user interface unit 20 may also be configured on a remote personal information device, such as a personal computer, a laptop computer, a smartphone, or a tablet device. In addition, each of the plurality of random number generating units 30 may be a roulette wheel, Sic Bo, Baccarat, or the like, as long as the plurality of game results can be randomly generated. The present application is not limited thereto.

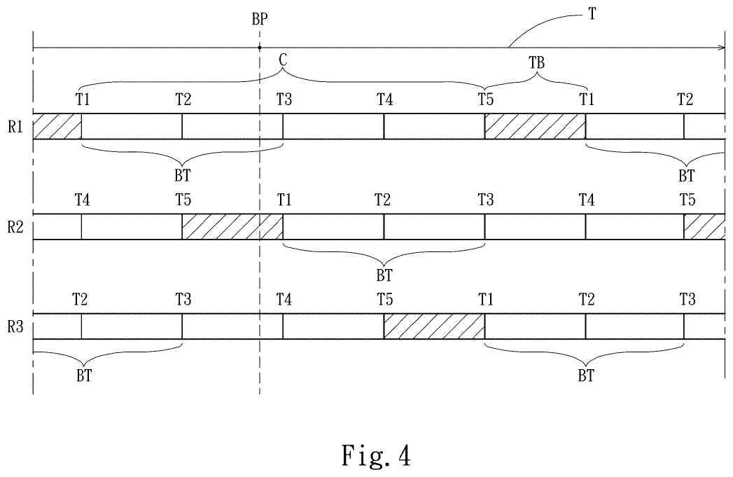

Referring to FIG. 4, the plurality of random number generating units 30 are connected respectively to the game processing unit 10 and operate repeatedly and independently on a time axis T according to cycle schedules C. Preferably, the number of the plurality of random number generating units 30 is between 3 and 12, but the present application is not limited thereto. In FIG. 4, three random number generating units 30 are illustrated for explanation and are numbered R1, R2, and R3, respectively.

In each cycle schedule C, each random number generating unit 30 randomly generates one of the plurality of game results according to the probability of occurrence of the plurality of game results. Each cycle schedule C includes a cycle starting point T1, an action starting time point T2, a stop-accepting-bets time point T3, a result display time point T4, and a cycle end point T5. The cycle starting point T1 and the cycle end point T5 are the starting point and the end point of one cycle schedule C. During execution of each cycle schedule C, the cycle end point T5 and the cycle starting point T1 of the next cycle schedule C may overlap or may be separated by a buffer time TB. The action starting time point T2 is the time point at which the random number generating unit 30 starts an action for generating one of the plurality of game results. For a physical roulette wheel, the action starting time point T2 may be the time point at which a ball is thrown into the roulette wheel. For Sic Bo, the action starting time point T2 may be the time point at which the dice cup covers the dice and the dice begin to roll. The application is not limited thereto. The result display time point T4 is the time point at which the random number generating unit 30 generates one of the plurality of game results. The stop-accepting-bets time point T3 is located between the action starting time point T2 and the result display time point T4. In other words, betting stops after a period of time has elapsed following the ball being thrown into the roulette wheel, and the time point at which betting stops is the stop-accepting-bets time point T3, i.e., a “no more bet” time point. More specifically, betting stops when the ball reaches a predetermined condition. The predetermined condition includes, but is not limited to, the ball having traveled around the roulette wheel for a certain number of circles, the centrifugal force of the ball having become insufficient and the ball beginning to fall toward the center of the roulette wheel, or a certain number of seconds having elapsed after air is blown.

Each random number generating unit 30 has an allowed betting period BT, i.e., “bet time” or “betting time”, in each cycle schedule C, and the allowed betting period BT is located between the cycle starting point T1 and the stop-accepting-bets time point T3. The allowed betting period BT is a time period during which the game processing unit 10 of the present application can accept bets placed by a player on the plurality of betting areas 22 through the user interface unit 20. The starting point of the allowed betting period BT is usually the cycle starting point T1, or may start after a short period of time following the cycle starting point T1, while the ending point of the allowed betting period BT is the stop-accepting-bets time point T3.

In practice, the actual time point of the stop-accepting-bets time point T3 and the result display time point T4 of a physical roulette wheel, i.e., a physical random number generating unit 30, cannot be controlled with complete precision, and only the action starting time point T2 can be controlled. More specifically, when the ball is thrown into the roulette wheel, i.e., at the action starting time point T2, the stop-accepting-bets time point T3 and the result display time point T4 are affected by environmental factors such as the landing point of the ball, the rolling trajectory, and atmospheric humidity, such that the actual operating time of different cycle schedules C varies slightly. On an extremely rare occasion, all of the plurality of random number generating units 30 may be outside the allowed betting period BT. If the game processing unit 10 determines that only one of the plurality of random number generating units 30 is in the allowed betting period BT, the game processing unit 10 delays the action starting time point T2 of the cycle schedule C of the random number generating unit 30 by a specified time. In this way, the stop-accepting-bets time point T3 is correspondingly delayed and the allowed betting period BT is lengthened, so that the allowed betting periods BT of the plurality of random number generating units 30 can better cover the entire time axis T, thereby ensuring that players betting at different times can each correspond to at least one allowed betting period BT of the plurality of random number generating units 30.

In addition, the game processing unit 10 may control the cycle schedules C of the plurality of random number generating units 30 to have different cycle starting points T1 on the time axis T. In one embodiment, the interval length between the cycle starting points T1 of the plurality of random number generating units 30 is negatively correlated with the number of the plurality of random number generating units 30. The greater the number of the plurality of random number generating units 30, the shorter the interval length between the cycle starting points T1. The game processing unit 10 controls the starting time of each cycle starting point T1 of the plurality of random number generating units 30. More specifically, the game processing unit 10 may delay the time at which a signal is sent, so that the random number generating unit 30 starts the cycle starting point T1 only when the random number generating unit 30 receives the signal from the game processing unit 10. In order to make the cycle schedules C of different random number generating units 30 have differences in operating time, thereby reducing a situation in which all of the plurality of random number generating units 30 are outside the allowed betting period BT, the cycle schedules C of the plurality of random number generating units 30 may be provided with different time lengths, respectively. More specifically, the game processing unit 10 may adjust the time points of the action starting time points T2 or the cycle end points T5 of the plurality of random number generating units 30 on the time axis T by advancing or delaying them.

The odds processing unit 40 is connected to the game processing unit 10 and generates a plurality of variable odds in each cycle schedule C of each random number generating unit 30. The plurality of variable odds respectively have probabilities to be selected. In each cycle schedule C, the odds processing unit 40 selects one of the variable odds according to the probability to be selected of each of the plurality of variable odds, so that the plurality of variable odds replace at least one of the plurality of payout odds in a many-to-one manner. In one embodiment, the plurality of variable odds may form a group corresponding to one of the payout odds to be replaced, and the sum of the probabilities to be selected of the plurality of variable odds in the group is 100%. In other words, the plurality of variable odds generated by the odds processing unit 40 may be divided into a plurality of groups corresponding to a plurality of payout odds.

When the plurality of variable odds replace at least one of the plurality of payout odds in a many-to-one manner, the RTP rate correspondingly has a variation value and a random odds set is generated in each cycle schedule C. In one embodiment, each random odds set includes only the plurality of variable odds, which means that all of the plurality of payout odds are replaced by the plurality of variable odds in a many-to-one manner. In other embodiments, each random odds set includes at least one variable odds and at least one payout odds, which means that a portion of the plurality of payout odds are replaced by the plurality of variable odds in a many-to-one manner.

It should be noted that the game system of the present application further includes a memory unit 70. Each random number generating unit 30 generates the random odds set in each cycle schedule C, and the random odds set is stored in historical game data of the memory unit 70. The random odds set is generated after the stop-accepting-bets time point T3. Therefore, when the player reviews the historical game data, if the random odds set includes a high numerical value, or even if the player wins by betting on the corresponding game result, the player can be attracted to continue playing.

In other embodiments, the odds processing unit 40 first determines at least one of an upper limit value, a lower limit value, or a quantity of the plurality of variable odds, so that the odds processing unit 40 generates the plurality of variable odds accordingly. More specifically, the odds processing unit 40 may first determine at least one of the upper limit value, the lower limit value, or the quantity of the plurality of variable odds according to preset settings of the game processing unit 10, player input, or the like. The application is not limited thereto. In this way, the computational complexity of generating the plurality of variable odds by the odds processing unit 40 can be simplified.

The upper limit value and the lower limit value of the plurality of variable odds are respectively the highest possible numerical value and the lowest possible numerical value of the plurality of variable odds, and the quantity of the plurality of variable odds is the number of possible values of the plurality of variable odds. In one embodiment, the upper limit value of the plurality of variable odds is not more than five times the original odds value, the lower limit value is not less than 75% of the original odds value, and the quantity is between 2 and 4, but the present application is not limited thereto.

In one embodiment, each of the plurality of variable odds generated by the odds processing unit 40 and the corresponding probability to be selected thereof are required to satisfy a condition that the variation value of the RTP rate is minimized. In addition, values of a portion of the plurality of variable odds are lower than values of corresponding ones of the payout odds. More specifically, the odds processing unit 40 randomly generates the quantity, odds values, and probabilities to be selected of the plurality of variable odds, and then uses a mathematical trial and error method to adjust the odds values and the probabilities to be selected of the plurality of variable odds until the variation value of the RTP rate is minimized. In other words, the difference between the RTP rate calculated by applying the plurality of variable odds and the corresponding probabilities to be selected and the RTP rate calculated by applying the payout odds is minimized.

For example, one example of the plurality of variable odds generated by the odds processing unit 40 is shown in Table 1.

TABLE 1

| variable odds | 27X | 42X | 101X | 175X |
|---|---|---|---|---|
| probabilities to be selected | 83% | 10% | 5% | 2% |

The plurality of variable odds, including the returned original bet, and the corresponding probabilities to be selected are respectively (28 times (27×), 83%; 43 times (42×), 10%; 102 times (101×), 5%; and 176 times (175×), 2%). These values form one group, and one of the plurality of variable odds is selected according to the corresponding probability to be selected and replaces the payout odds in a many-to-one manner. The average value of the replacing variable odds is calculated as 36.16 times, i.e., 28*83%+43*10%+102*5%+176*2%. Therefore, the RTP rate becomes 1/39*36.16≈92.72%. Since the original RTP rate is 92.31%, the variation value is 92.72%−92.31%=0.41%. It is worth mentioning that, in another embodiment, the plurality of variable odds shown in Table 1 may also be generated after the odds processing unit 40 determines the upper limit value, the lower limit value, and the quantity of the plurality of variable odds as 175×, 27×, and 4, respectively. The application is not limited thereto.

In order to satisfy the condition that the variation value of the RTP rate is minimized, the odds processing unit 40 adjusts the odds values of the plurality of variable odds and the numerical values of the corresponding probabilities to be selected. For example, as shown in Table 2, when the value of the variable odds is adjusted from 175× to 167×, the average value of the variable odds becomes 36 times, i.e., 28*83%+43*10%+102*5%+168*2%.

TABLE 2

| variable odds | 27X | 42X | 101X | 167X |
|---|---|---|---|---|
| probabilities to be selected | 83% | 10% | 5% | 2% |

Since the average value of the variable odds replacing the payout odds is 36 times, which is the same as the original odds value, the RTP rate is 92.31% and the variation value is 0. Therefore, the condition that the variation value of the RTP rate is minimized is satisfied.

When the plurality of variable odds replace at least one of the plurality of payout odds in a many-to-one manner, the random odds set is generated. One example of the random odds set is shown in Table 3, in which only the portion of the plurality of payout odds that is replaced by the plurality of variable odds is shown. The payout odds for the game results of single numbers 3, 5, 20, 24, and 30 are 36 times (35×). After replacement by the plurality of variable odds, i.e., 28 times (27×), 28 times (27×), 102 times (101×), 43 times (42×), and 28 times (27×), the result is shown in Table 3.

TABLE 3

| Game results | Replaced odds |
|---|---|
| Single number 3 | 27X |
| Single number 5 | 27X |
| Single number 20 | 101X |
| Single number 24 | 42X |
| Single number 30 | 27X |

It should be noted that the calculations above and generation of the random odds set are based on a simplified Triple Zero Roulette game having only 39 game results, namely 0, 00, 000, and 1 to 36, and the original odds value of the payout odds for each single number is 36 times. In one embodiment, Triple Zero Roulette includes not only single-number bets, but also red/black, odd/even, and number-range bets. Different game plays have different betting options, and each betting option has a different probability of occurrence and a different payout odds, from which the RTP rate can be calculated. Therefore, the same calculation method can also be used to generate a plurality of variable odds and replace at least one of the plurality of payout odds in a many-to-one manner so as to generate a random odds set. Similarly, the same logic can be directly applied to other types of roulette, Sic Bo, Baccarat, or other random number generating units 30 capable of randomly generating game results, and therefore details are omitted herein.

In one embodiment, the game processing unit 10 further determines whether the odds processing unit 40 is allowed to generate the plurality of variable odds according to a preset condition. In one embodiment, the preset condition may be that the player selects whether the plurality of variable odds are to be generated. When the preset condition is not to generate the plurality of variable odds, the needs of players who do not prefer variable odds can be satisfied.

In addition, in one embodiment, the memory unit 70 stores a plurality of odds tables, and the plurality of odds tables respectively record a set of the plurality of variable odds, and each set of the plurality of variable odds is distinct from one another. The plurality of odds tables stored in the memory unit 70 may be randomly generated in advance or input and stored in the memory unit 70. Some of the plurality of variable odds also have lower numerical values than the corresponding payout odds, which helps avoid computational complexity and difficulty. After the game processing unit 10 receives an activation signal, the game processing unit 10 activates one of the plurality of odds tables. The activation signal may be generated through input via the user interface unit 20, or one of the plurality of odds tables may be activated by default according to a preset value. In other words, the player may select and activate the odds table on the basis of which the player wishes to play. The game processing unit 10 further controls the odds processing unit 40 to replace at least one of the plurality of payout odds with the plurality of variable odds recorded in the activated odds table in a many-to-one manner. Accordingly, while minimizing a variation value in a Return to Player (RTP) rate, the payout odds may have a chance to be replaced with variable odds having higher numerical values, thereby increasing volatility of the game provided by the game system of the present application and further attracting players to play.

In one embodiment, the memory unit 70 further stores a basic odds table. When the activation signal is a signal for activating the basic odds table, the odds processing unit 40 directly uses the plurality of payout odds for payout. In other words, the plurality of payout odds serve as the random odds set for players who do not prefer variable odds, thereby satisfying the preferences of different players. Players who do not pursue high volatility but instead prefer a more stable game experience may also select the basic odds table.

In another embodiment, the game may be provided with a plurality of basic odds corresponding respectively to the plurality of game results. The plurality of basic odds are also a kind of payout odds, but have lower original odds values. Likewise, the RTP rate is calculated according to the probabilities of occurrence of the plurality of game results and the plurality of basic odds.

Taking the above-mentioned Triple Zero Roulette as an example, if the game results are simplified into only 39 kinds, namely 0, 00, 000, and 1 to 36, the original odds value of each basic odds for single numbers, namely 0, 00, 000, and 1 to 36, may be set at 28 times, including the returned original bet. Therefore, the RTP rate is about 71.79%, i.e., 1/39*28. The odds values of the plurality of variable odds are greater than or equal to the odds values of the corresponding basic odds. In other words, when the plurality of variable odds replace at least one of the plurality of basic odds, namely the 39 results of 0, 00, 000, and 1 to 36, in a many-to-one manner, the odds values only remain unchanged or increase and do not decrease. In other words, in this embodiment, the RTP rate only remains unchanged or increases. In this way, a situation in which the basic odds are replaced by variable odds having lower numerical values, thereby causing a decrease in the odds values, can be avoided. Thus, the player can be further prevented from feeling that the odds values have been “reduced”, which helps increase the player's sense of trust in the game system of the present application.

In one embodiment, one example of the plurality of variable odds generated by the odds processing unit 40 is shown in Table 4.

TABLE 4

| variable odds | 27X | 40X | 100X | 168X |
|---|---|---|---|---|
| probabilities to be selected | 83% | 10% | 5% | 2% |

The plurality of variable odds, including the returned original bet, and the corresponding probabilities to be selected are respectively (28 times (27×), 83%; 41 times (40×), 10%; 101 times (100×), 5%; and 169 times (168×), 2%).

When one of the variable odds is selected according to the corresponding probability to be selected and replaces at least one of the plurality of basic odds in a many-to-one manner, the average value after replacement is calculated as 35.77 times, i.e., 28*83%+41*10%+101*5%+169*2%.

That is, in this embodiment, none of the plurality of basic odds are replaced by variable odds having lower numerical values. When all of the plurality of basic odds are respectively selected according to the probabilities to be selected of the variable odds described above and are replaced by the variable odds in a many-to-one manner, the RTP rate is calculated as 1/39*35.77≈91.72%. It is worth mentioning that, when any of the variable odds is the same as the corresponding one of the plurality of basic odds according to the probability to be selected, for example, variable odds 27× replacing basic odds 27×, the odds processing unit 40 may regard this situation as the variable odds “replacing” the basic odds, or may regard this situation as the variable odds “not replacing” the basic odds.

Taking the above-mentioned Triple Zero Roulette as an example, in one embodiment, the original odds value of the basic odds for a single number may be set at 30 times, including the returned original bet. Therefore, the RTP rate is about 76.92%, i.e., 1/39*30. In one embodiment, each of the plurality of variable odds and the corresponding probability to be selected thereof satisfy a condition that the variation value of the RTP rate is increased by a specified value. The specified value may be set or modified according to operating profit considerations or to satisfy regulatory requirements. For example, the RTP rate of the above-mentioned Triple Zero Roulette is about 76.92%. In one embodiment, the specified value is set so that the RTP rate is not lower than a regulatory requirement of 85%. The specified value may be set at 11%, such that each of the plurality of variable odds and the corresponding probability to be selected thereof satisfy a condition that the RTP rate becomes 87.92%.

One embodiment of the specific odds values of the plurality of variable odds generated by the odds processing unit 40 and the corresponding probabilities to be selected thereof is shown in Table 5.

TABLE 5

| variable odds | 32X | 38X | 50X | 140X |
|---|---|---|---|---|
| probabilities to be selected | 90% | 8% | 1.5% | 0.5% |

When one of the variable odds is selected according to the corresponding probability to be selected and replaces one of the plurality of basic odds in a many-to-one manner, the average value after replacement is calculated as 34.29 times, i.e., 33*90%+39*8%+51*1.5%+141*0.5%. Therefore, the RTP rate is calculated as 1/39*34.29≈87.92%, thereby satisfying the condition that the variation value of the RTP rate becomes 87.92%.

In one embodiment, the memory unit 70 likewise stores a plurality of odds tables. The plurality of odds tables respectively record a set of the plurality of variable odds, and each set of the plurality of variable odds is distinct from one another. The plurality of odds tables stored in the memory unit 70 may be pre-generated randomly or stored in the memory unit 70 through input. The odds values of the plurality of variable odds recorded in the odds tables are greater than or equal to the odds values of the corresponding basic odds, thereby helping avoid cumbersome and difficult calculations and, in particular, helping reduce the calculation burden on R&D personnel. After the game processing unit 10 activates one of the plurality of odds tables, the game processing unit 10 controls the odds processing unit 40 to replace at least one of the plurality of basic odds with the plurality of variable odds recorded in the activated odds table in a many-to-one manner.

Referring to FIGS. 1, 3, and 4, the betting unit 50 is connected to the game processing unit 10 and receives a bet 23 on the plurality of betting areas 22 in the game round. In one embodiment, when the player places chips on the plurality of betting areas 22, selection of the bet 23 is completed. The player may then confirm selection of the bet 23 by pressing a confirm button 24, and the confirm button 24 generates a betting signal. It should be noted that actions such as “placing” or “pressing” described above are not limited to actions performed through the user interface unit 20 disposed on the gaming machine 1 or on the remote device, and are also not limited to operations such as tapping a touch screen or clicking a button, a mouse, or any other manner.

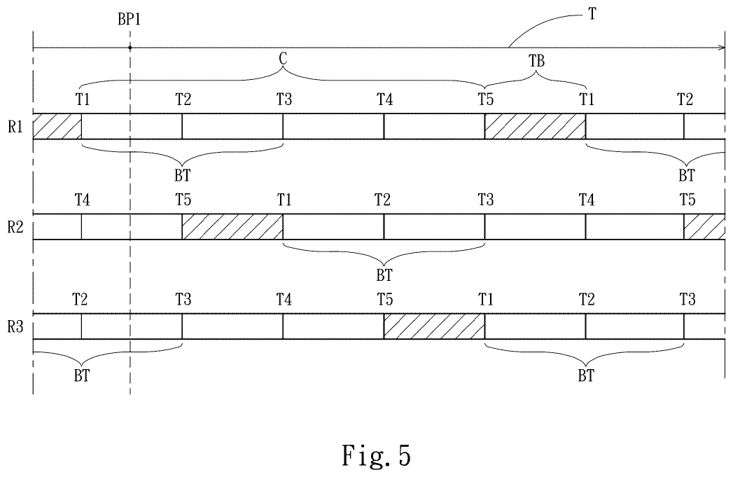

When at least one of the plurality of random number generating units 30 is in the allowed betting period BT, or when one of the plurality of random number generating units 30 is about to enter the allowed betting period BT, if the player places chips on the plurality of betting areas 22 and thereby completes selection of the bet 23, the betting unit 50 generates temporary betting data according to the chips placed on the plurality of betting areas 22. When the betting unit 50 receives the betting signal from the confirm button 24, the temporary betting data are converted into betting data, and a finished-betting time point BP is formed on the time axis T. At the same time, the game processing unit 10 filters the plurality of random number generating units 30 to identify those satisfying a filtering condition. The filtering condition is that the random number generating units 30 are in the allowed betting period BT at the finished-betting time point BP. As shown in FIG. 4, only the random number generating unit 30 numbered R1 satisfies the filtering condition. As shown in FIG. 5, which is a schematic diagram of another finished-betting time point BP1, the random number generating units 30 numbered R1 and R3 both satisfy the filtering condition.

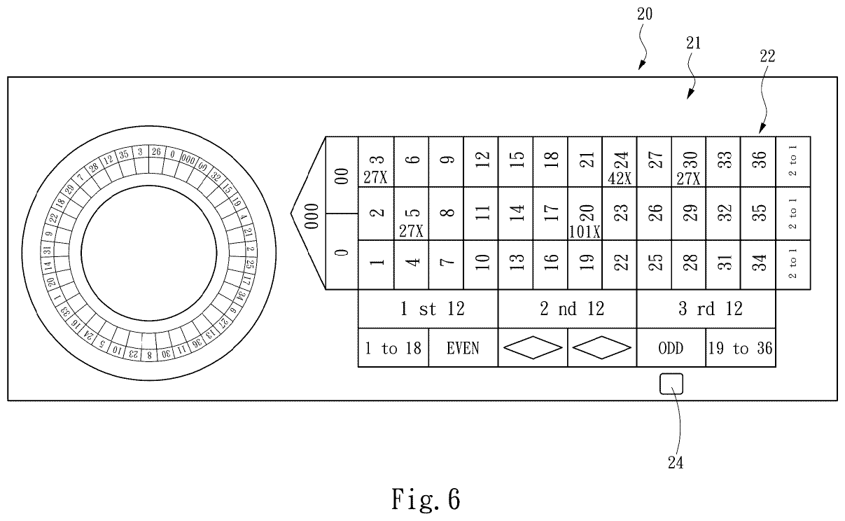

Referring further to FIGS. 1, 4, and 6, the game processing unit 10 further obtains the random odds set used in the latest cycle schedule C among the plurality of random number generating units 30 satisfying the filtering condition, and controls the plurality of betting areas 22 to display the random odds set after the stop-accepting-bets time point T3 on the time axis T. For example, positions corresponding to the game results of single numbers 3, 5, 20, 24, and 30 on the plurality of betting areas 22 respectively display the variable odds of the corresponding random odds set as 28 times (27×), 28 times (27×), 102 times (101×), 43 times (42×), and 28 times (27×). In this way, by displaying the random odds set, when the random odds set includes variable odds having high numerical values, players are encouraged to continue placing bets in the next game round.

Referring further to FIGS. 1 and 4, the payout unit 60 is connected to the game processing unit 10. After the finished-betting time point BP, the game processing unit 10 obtains the latest generated game result in the cycle schedule C among the plurality of random number generating units 30 satisfying the filtering condition, and controls the payout unit 60 to pay out according to the latest generated game result, the betting data, and the random odds set.

It should be particularly noted that, when only one random number generating unit 30 satisfies the filtering condition, the payout unit 60 pays out according to the game result generated in the latest cycle schedule C by the random number generating unit 30 satisfying the filtering condition. In other words, taking FIG. 4 as an example, payout is made according to the game result generated by the random number generating unit 30 numbered R1 at its result display time point T4.

Referring to FIG. 5, when two or more of the plurality of random number generating units 30 satisfy the filtering condition, one of the plurality of random number generating units 30 satisfying the filtering condition is selected in an either- or manner, and payout is made according to the game result generated in the latest cycle schedule C and the random odds set used therein. The either- or manner may be random selection of one of the plurality of random number generating units 30, or selection of the random number generating unit 30 that generates the game result earlier. Continuing with FIG. 5 as an example, if the random number generating unit 30 that generates the game result earlier is selected, payout is made according to the game result generated by the random number generating unit 30 numbered R3 at its result display time point T4.

In other embodiments, the payout unit 60 may pay out not only according to the latest generated game result in the cycle schedule C, but may also respectively have a probability of paying out according to the game results generated in subsequent cycle schedules C and the random odds sets used therein. In other words, for the random number generating units 30 that are in the allowed betting period BT, the game results generated in the latest cycle schedule C and the random odds sets used therein each have a probability of being used for payout, so that the player can win multiple payouts through one bet. Again taking FIG. 5 as an example, the game results generated by the random number generating units 30 numbered R1 and R3 at their respective result display time points T4 each have a probability of being used for payout, so that the player can win two payouts through one bet.

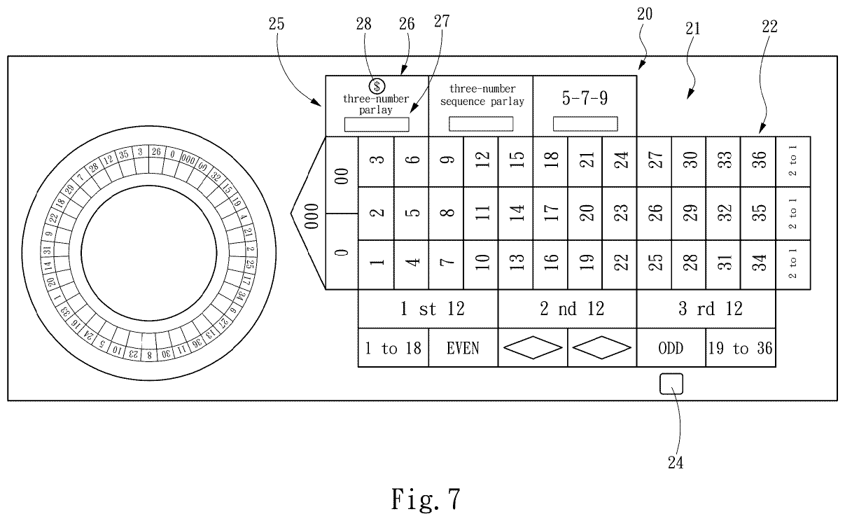

Referring to FIGS. 1 and 7, the user interface unit 20 further includes a side bet area 25. The side bet area 25 has at least one parlay combination betting area 26 and at least one parlay odds 27 corresponding thereto. Each parlay combination betting area 26 includes at least two of the plurality of game results. When the betting unit 50 receives a parlay bet 28 on the parlay combination betting areas 26 in the side bet area 25, the payout unit 60 obtains the plurality of game results most recently generated by the plurality of random number generating units 30, and the plurality of game results match the quantity of at least two game results included in each parlay combination betting area 26. The parlay bet 28 includes a selection of the plurality of game results and a parlay bet amount, and the selection corresponds to the at least two game results included in each parlay combination betting area 26. When the latest generated plurality of game results matching the quantity are compared with the selection of the at least two game results included in each parlay combination betting area 26, and the comparison result is the same, the payout unit 60 pays out according to the parlay odds 27 of each parlay combination betting area 26 and the parlay bet amount.

In one embodiment, the comparison does not include the order of the selection made for the parlay bet 28 or the order in which the plurality of game results are generated. In another embodiment, the comparison includes the order of the selection made for the parlay bet 28 and the order in which the plurality of game results are generated.

For example, if the quantity of the at least two game results included in each parlay combination betting area 26 is three, each parlay combination betting area 26 includes three game results, and the respective parlay combination betting areas 26 may be a three-number parlay, a three-number sequence parlay, and a three-number bet, which are described in detail below.

When the player places a bet on the three-number parlay, the player needs to make the selection again to complete the three-number parlay. The selection is any three game results selected from among the plurality of game results, for example, 0, 00, 000, and 1 to 36 in Triple Zero Roulette. When the latest three game results generated by the plurality of random number generating units 30 match the selected three game results, regardless of the order in which the game results are generated, the three-number parlay is deemed to win, and the payout unit 60 pays out according to the corresponding parlay odds 27. Taking FIG. 5 as an example, when the player completes the three-number parlay at betting time point BP1, the latest three game results are the game result generated by the random number generating unit 30 numbered R1 at its result display time point T4, the game result generated by the random number generating unit 30 numbered R2 at its result display time point T4, and the game result generated by the random number generating unit 30 numbered R3 at its result display time point T4.

When the player places a bet on the three-number sequence parlay, the player likewise needs to make the selection to complete the three-number sequence parlay. The selection is any three game results selected from among the plurality of game results, for example, 0, 00, 000, and 1 to 36 in Triple Zero Roulette, and the order of the selection is recorded. When the latest three game results generated by the plurality of random number generating units 30 match the selection and the order of the selection in the generated order, the three-number sequence parlay is deemed to win. Taking FIG. 5 as an example, when the player completes the three-number sequence parlay at betting time point BP1, the latest three game results are, in sequence, the game result generated by the random number generating unit 30 numbered R3 at its result display time point T4, the game result generated by the random number generating unit 30 numbered R1 at its result display time point T4, and the game result generated by the random number generating unit 30 numbered R2 at its result display time point T4.

When the player places a bet on the three-number bet, three of the plurality of game results, for example, 0, 00, 000, and 1 to 36 in Triple Zero Roulette, are directly displayed on the parlay combination betting area 26. The displayed three game results may be the three game results most frequently bet on by players, or the selection of the previous parlay bet 28. In one embodiment, as shown in the drawings, the three-number bet displays game results (5-7-9), representing a bet on a three-number sequence parlay of 5-7-9. In this way, the selection step is unnecessary, which saves the time required for the selection and accelerates game progress. In this case, the three-number sequence parlay wins as long as the latest three generated game results are, in sequence, 5-7-9.

In another embodiment, the three-number bet displays game results (5/7/9), representing a bet on a three-number parlay of 5/7/9. In this case, regardless of the order in which the game results are generated, the three-number parlay wins as long as the latest three generated game results are 5/7/9.

Referring further to FIG. 1, in one embodiment, each random number generating unit 30 may further be combined with live streaming. In one embodiment, each random number generating unit 30 is broadcast live in real time through a camera device, which is not illustrated, in a single continuous shot, so as to live-stream the process of generating each game result. A live image generated by the camera device may be transmitted to the user interface unit 20 in real time for viewing by the player. Since the live image is unedited and transmitted in real time, or near real time with very low delay, the player's suspicion of fabrication can be reduced, thereby increasing credibility of the game system of the present application.

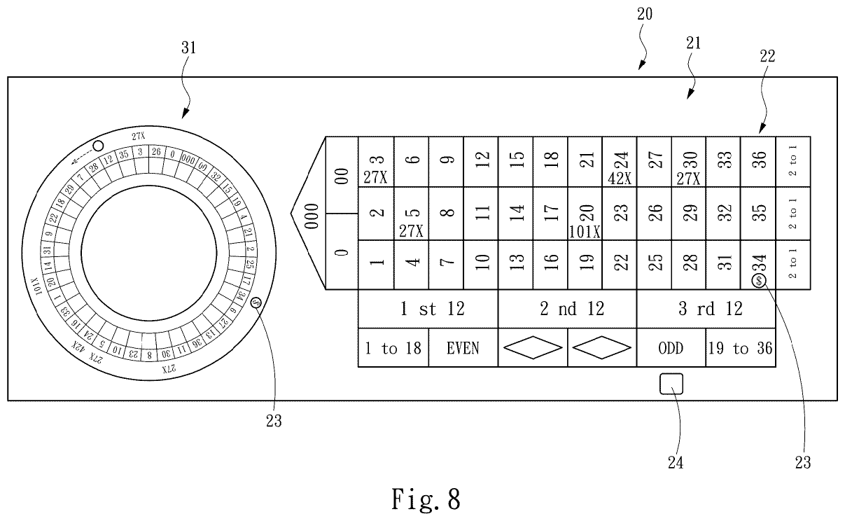

Referring further to FIGS. 1 and 8, in one embodiment, the game processing unit 10 analyzes the live image to generate location information, and the game processing unit 10 generates a synthesized image 31 according to the betting data, the live image, and the location information. More specifically, after obtaining the location information of the live image from the camera device, the game processing unit 10 may convert each bet 23 in the betting data into an image and combine the image with the live image as a part of the synthesized image 31. The synthesized image 31 is transmitted to the user interface unit 20 in real time, so that the user interface unit 20 displays the synthesized image 31. In this way, by directly viewing the synthesized image 31, the player can simultaneously and directly keep track of game progress and the numerical values of the bets 23 on the user interface unit 20, without being distracted by having to monitor both the numerical values of the bets 23 and the live image at the same time, thereby avoiding additional mental burden and further helping increase player retention in the game system of the present application.

In another embodiment, the game processing unit 10 converts the variable odds displayed for the game results of single numbers 3, 5, 20, 24, and 30, namely 28 times (27×), 28 times (27×), 102 times (101×), 43 times (42×), and 28 times (27×), into images and uses the images as a part of the synthesized image 31. In this way, the player can learn occurrence of the variable odds through the synthesized image 31.

Accordingly, the present application, as compared with conventional technologies, has at least the following advantages:
1. The odds processing unit selects one of the variable odds according to the probability to be selected of each of the plurality of variable odds, so that the plurality of variable odds replace at least one of the plurality of payout odds in a many-to-one manner to generate the random odds set. The random odds set may include high numerical values of odds, thereby increasing volatility of the game provided by the game system of the present application.
2. Through the design of the plurality of random number generating units, when a bet is accepted, the latest generated game result of the plurality of random number generating units can be used for payout, thereby greatly reducing waiting time. In addition, according to the needs of different players, betting may be placed rapidly and continuously, or only after sufficient consideration, thereby increasing enjoyment of the game provided by the game system of the present application.
3. The side bet area of the user interface unit can provide parlay bet game plays, and bets are placed based on the respective game results generated by the plurality of random number generating units, thereby accelerating game progress and solving a problem that long waiting is required when game results are generated by only one random number generating unit.

What is claimed is:

1. A game system comprising:
a game processing unit configured to control operation of a game and to allow a player to play a game round;
a user interface unit connected to the game processing unit and configured to display a game screen of the game round and a plurality of betting areas, the plurality of betting areas corresponding respectively to a plurality of game results of the game;
a plurality of random number generating units connected to the game processing unit and configured to operate repeatedly and independently on a time axis according to cycle schedules, wherein in each of the cycle schedules, each of the random number generating units randomly generates one of the plurality of game results according to a probability of occurrence of the plurality of game results, each of the cycle schedules including a cycle starting point, an action starting time point, a stop-accepting-bets time point, a result display time point, and a cycle end point, the stop-accepting-bets time point being located between the action starting time point and the result display time point, and each of the random number generating units having, in each of the cycle schedules, an allowed betting period located between the cycle starting point and the stop-accepting-bets time point;
an odds processing unit connected to the game processing unit and configured to generate a plurality of variable odds in each of the cycle schedules of each of the random number generating units, and the plurality of variable odds respectively having a probability to be selected, wherein the odds processing unit selects one of the variable odds according to the probability to be selected of each of the variable odds, and the plurality of variable odds replace at least one of a plurality of payout odds in a many-to-one manner, so that a Return to Player (RTP) rate of the game has a variation value and the odds processing unit generates a random odds set in each of the cycle schedules of each of the random number generating units, and wherein values of a portion of the plurality of variable odds are lower than values of corresponding ones of the plurality of payout odds;
a betting unit connected to the game processing unit and configured to receive a bet on the plurality of betting areas in the game round, wherein when at least one of the plurality of random number generating units is in the allowed betting period, the betting unit ends betting upon receiving a betting signal to generate betting data and forms a finished-betting time point on the time axis, and the game processing unit filters the plurality of random number generating units to identify those satisfying a filtering condition that the random number generating units are in the allowed betting period at the finished-betting time point, the game processing unit further obtains the random odds set used in the latest cycle schedule among the random number generating units satisfying the filtering condition and, after the stop-accepting-bets time point on the time axis, the game processing unit controls the plurality of betting areas to display the random odds set; and
a payout unit connected to the game processing unit, wherein after the finished-betting time point, the game processing unit obtains the latest generated game result in the cycle schedule among the random number generating units satisfying the filtering condition and controls the payout unit to pay out according to the latest generated game result, the betting data, and the random odds set,
wherein the game has the RTP rate, the plurality of game results, and the plurality of payout odds corresponding respectively to the plurality of game results, the plurality of game results having probabilities of occurrence, respectively, and the RTP rate being calculated according to the probabilities of occurrence of the plurality of game results and the plurality of payout odds.

2. The game system of claim 1, wherein each of the variable odds and the corresponding probability to be selected thereof satisfy a condition that the variation value of the RTP rate is minimized.

3. The game system of claim 1, wherein the odds processing unit obtains at least one of an upper limit value, a lower limit value, or a quantity of the plurality of variable odds, according to which the odds processing unit generates the plurality of variable odds.

4. The game system of claim 1, wherein when two or more of the plurality of random number generating units satisfy the filtering condition, the payout unit not only pays out according to the latest generated game result generated in a corresponding one of the cycle schedules, but also has a probability of paying out according to each of the game results generated in subsequent cycle schedules and each of the random odds sets used therein.

5. The game system of claim 1, wherein the user interface unit further includes a side bet area, the side bet area having at least one parlay combination betting area and at least one parlay odds corresponding thereto, each of the at least one parlay combination betting area including at least two of the plurality of game results;
wherein when the betting unit receives a parlay bet on the at least one parlay combination betting area in the side bet area, the payout unit obtains a plurality of latest generated game results from the plurality of random number generating units that match a quantity of the at least two game results included in each of the at least one parlay combination betting area, the parlay bet including a selection of the plurality of game results corresponding to the at least two game results included in each of the at least one parlay combination betting area and a parlay bet amount; and
wherein when the latest generated plurality of game results matching the quantity are compared with the selection of the at least two game results included in each of the at least one parlay combination betting area and a comparison result is same, the payout unit pays out according to the parlay odds of each of the at least one parlay combination betting area and the parlay bet amount.

6. The game system of claim 5, wherein the comparison does not include an order of the selection made for the parlay bet and an order in which the plurality of game results are generated.

7. The game system of claim 5, wherein the comparison includes an order of the selection made for the parlay bet and an order in which the plurality of game results are generated.

8. The game system of claim 1, wherein when only one of the plurality of random number generating units is in the allowed betting period, the game processing unit delays the action starting time point of the cycle schedule of the random number generating unit by a specified time.

9. The game system of claim 1, wherein the game processing unit controls the cycle schedules of the plurality of random number generating units to have different cycle starting points on the time axis, respectively.

10. The game system of claim 1, wherein the game system further comprises a memory unit configured to store a plurality of odds tables, the plurality of odds tables respectively recording a set of the plurality of variable odds, wherein after the game processing unit receives an activation signal, the game processing unit activates one of the plurality of odds tables and controls the odds processing unit to replace at least one of the plurality of payout odds with the plurality of variable odds recorded in the activated odds table in a many-to-one manner, and wherein in each of the odds tables, values of a portion of the plurality of variable odds are lower than values of corresponding ones of the plurality of payout odds.

11. The game system of claim 10, wherein the memory unit further stores a basic odds table, and, when the activation signal activates the basic odds table, the odds processing unit directly uses the plurality of payout odds for payout.

12. A game system comprising:
a game processing unit configured to control operation of a game and to allow a player to play a game round;
a user interface unit connected to the game processing unit and configured to display a game screen of the game round and a plurality of betting areas, the plurality of betting areas corresponding respectively to a plurality of game results of the game;
a plurality of random number generating units connected to the game processing unit and configured to operate repeatedly and independently on a time axis according to cycle schedules, wherein in each of the cycle schedules, each of the random number generating units randomly generates one of the plurality of game results according to a probability of occurrence of the plurality of game results, each of the cycle schedules including a cycle starting point, an action starting time point, a stop-accepting-bets time point, a result display time point, and a cycle end point, the stop-accepting-bets time point being located between the action starting time point and the result display time point, and each of the random number generating units having, in each of the cycle schedules, an allowed betting period located between the cycle starting point and the stop-accepting-bets time point;
an odds processing unit connected to the game processing unit and configured to generate a plurality of variable odds in each of the cycle schedules of each of the random number generating units, and the plurality of variable odds respectively having a probability to be selected, wherein the odds processing unit selects one of the variable odds according to the probability to be selected of each of the variable odds, and the plurality of variable odds replace at least one of a plurality of basic odds in a many-to-one manner, so that a Return to Player (RTP) rate of the game has a variation value and generates a random odds set in each of the cycle schedules of each of the random number generating units, and wherein odds values of the plurality of variable odds are greater than or equal to odds values of corresponding ones of the plurality of basic odds;
a betting unit connected to the game processing unit and configured to receive a bet on the plurality of betting areas in the game round, wherein when at least one of the plurality of random number generating units is in the allowed betting period, the betting unit ends betting upon receiving a betting signal to generate betting data and forms a finished-betting time point on the time axis, and the game processing unit filters the plurality of random number generating units to identify those satisfying a filtering condition that the random number generating units are in the allowed betting period at the finished-betting time point, the game processing unit further obtains the random odds set used in the latest cycle schedule among the random number generating units satisfying the filtering condition and, after the stop-accepting-bets time point on the time axis, the game processing unit controls the plurality of betting areas to display the random odds set; and
a payout unit connected to the game processing unit, wherein after the finished-betting time point, the game processing unit obtains the latest generated game result in the cycle schedule among the random number generating units satisfying the filtering condition and controls the payout unit to pay out according to the latest generated game result, the betting data, and the random odds set,
wherein the game has the RTP rate, the plurality of game results, and the plurality of basic odds corresponding respectively to the plurality of game results, the plurality of game results having probabilities of occurrence, respectively, and the RTP rate being calculated according to the probabilities of occurrence of the plurality of game results and the plurality of basic odds.

13. The game system of claim 12, wherein each of the variable odds and the corresponding probability to be selected thereof satisfy a condition that the variation value of the RTP rate is increased by a specified value.

14. The game system of claim 12, wherein the odds processing unit obtains at least one of an upper limit value or a quantity of the plurality of variable odds, and generates the plurality of variable odds accordingly.

15. The game system of claim 12, wherein when two or more of the plurality of random number generating units satisfy the filtering condition, the payout unit not only pays out according to the latest generated game result generated in a corresponding one of the cycle schedules, but also has a probability of paying out according to each of the game results generated in subsequent cycle schedules and each of the random odds sets used therein.

16. The game system of claim 12, wherein the user interface unit further includes a side bet area, the side bet area having at least one parlay combination betting area and at least one parlay odds corresponding thereto, each of the at least one parlay combination betting area including at least two of the plurality of game results;
wherein when the betting unit receives a parlay bet on the at least one parlay combination betting area in the side bet area, the payout unit obtains a plurality of latest generated game results from the plurality of random number generating units that match a quantity of the at least two game results included in each of the at least one parlay combination betting area, the parlay bet including a selection of the plurality of game results corresponding to the at least two game results included in each of the at least one parlay combination betting area and a parlay bet amount; and
wherein when the latest generated plurality of game results matching the quantity are compared with the selection of the at least two game results included in each of the at least one parlay combination betting area and a comparison result is same, the payout unit pays out according to the parlay odds of each of the at least one parlay combination betting area and the parlay bet amount.

17. The game system of claim 16, wherein the comparison does not include an order of the selection made for the parlay bet and an order in which the plurality of game results are generated.

18. The game system of claim 16, wherein the comparison includes an order of the selection made for the parlay bet and an order in which the plurality of game results are generated.

19. The game system of claim 12, wherein when only one of the plurality of random number generating units is in the allowed betting period, the game processing unit delays the action starting time point of the cycle schedule of the random number generating unit by a specified time.

20. The game system of claim 12, wherein the game processing unit controls the cycle schedules of the plurality of random number generating units to have different cycle starting points on the time axis, respectively.

21. The game system of claim 12, wherein the game system further comprises a memory unit configured to store a plurality of odds tables, the plurality of odds tables respectively recording a set of the plurality of variable odds, wherein after the game processing unit receives an activation signal, the game processing unit activates one of the plurality of odds tables and controls the odds processing unit to replace at least one of the plurality of basic odds with the plurality of variable odds recorded in the activated odds table in a many-to-one manner, and wherein in each of the odds tables, odds values of the plurality of variable odds are greater than or equal to odds values of corresponding ones of the plurality of basic odds.
